(19) United States
(12) Patent Application Publication
(10) Pub. No.: US 2026/0202231 A1
(43) Pub. Date: Jul. 16, 2026

(54) COLLAPSIBLE UNIVERSAL JIGGER WITH MAGNETIC RING

(71) Applicant: Donald Jaramillo, Albuquerque, NM (US)

(72) Inventor: Donald Jaramillo, Albuquerque, NM (US)

(21) Appl. No.: 19/025,504

(22) Filed: Jan. 16, 2025

(51) Int. Cl. G01F 22/00

(52) U.S. Cl. CPC G01F 22/00

(57) ABSTRACT

In an embodiment, a multifunctional ring apparatus can include a ring portion and one or more magnets connected to or integrated within the ring portion. The multifunctional ring apparatus can further include one or more measuring cups, each measuring cup comprising a magnetized end or a magnet connected thereto. The magnet(s) of the ring portion can be configured to detachably connect to the magnetized end or the magnet of any of the one or more measuring cups, thereby enabling secure attachment of the measuring cup to the ring portion. The magnetic connection can permit a group of measuring cups to be sequentially or simultaneously attached to the ring portion. In an embodiment, multifunctional ring apparatus may function as a collapsible universal jigger with the ring portion.

### TECHNICAL FIELD

Embodiments are related to multifunctional ring devices. Embodiments further relate to bar jiggers. Embodiments further relate to a ring apparatus incorporating magnetic features for liquid measurement applications, such as bartending, and for interacting with magnetic locking mechanisms to enhance security for devices such as safes, cabinets, or other access-controlled systems.

### BACKGROUND

In the hospitality and culinary industries, precise liquid measurement is essential, particularly for bartenders who must mix beverages quickly and accurately during peak hours. Traditionally, liquid measurements are conducted using measuring cups, jiggers, or other standalone tools that are often misplaced or inconvenient to access in fast-paced environments. This creates inefficiencies and increases the potential for errors in liquid proportions, which can affect the consistency and quality of the final product.

A bar jigger, often referred to simply as a jigger, is a small, hourglass-shaped measuring tool used in bartending to ensure precise measurements of liquid ingredients when crafting cocktails. Typically made of stainless steel, jiggers come in various sizes, with common capacities including 1 ounce and 1.5 ounces on opposite ends. The jigger is a vital tool in bartending as it promotes consistency, balance, and professionalism in drink preparation. By accurately measuring spirits, syrups, and other mixers, bartenders can create cocktails that maintain the intended flavor profile and strength, ensuring customer satisfaction and reducing waste. Its importance lies in its ability to elevate the quality of beverages, streamline service, and uphold the reputation of a skilled mixologist.

Efforts to improve convenience and accuracy in liquid measurement have led to innovations such as magnetic attachments for organizing tools. However, existing solutions are limited in their portability and integration into wearable devices.

Space constraints are a common issue in the bartending industry, particularly in environments where efficiency and quick access to tools are critical. One of the main challenges bartenders face is the limited space available on bar ledges or lips, which are often crowded with glassware, bottles, garnishes, and other necessary tools. In addition to this, many bars operate in tight spaces where counters or prep areas are limited, which can hinder a bartender's ability to organize and access equipment quickly. This lack of space makes it difficult for bartenders to store and access the variety of tools and devices that are integral to preparing and serving drinks, such as jiggers, muddler sticks, bottle openers, shakers, and measuring cups.

As a result, there is an ongoing need for compact, multi-functional bartending tools and storage solutions that maximize available space on the bar while maintaining efficiency and accessibility. The ability to store tools securely and in an organized manner is especially important in high-paced environments, where bartenders need to minimize movement, quickly grab the right tool, and maintain a smooth workflow. A more compact solution would also help reduce clutter on the bar and improve the overall aesthetics of the workspace, which is essential in creating a professional and organized atmosphere.

There is also a growing demand for modular solutions that can adapt to different bar layouts and accommodate varying numbers of bartenders or customers. These solutions should enable bartenders to customize their workspace, easily access essential tools, and maintain a high level of organization without sacrificing the speed or quality of service.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the embodiments to provide for an improved multifunctional ring device.

It is also an aspect of the embodiments to provide for an improved bar jigger.

It is a further aspect of the embodiments to provide for a collapsible universal jigger with a magnetic ring.

It is another aspect of the embodiments to provide for a ring apparatus incorporating magnetic features for liquid measurement applications, such as bartending.

It is also an aspect of the embodiments to provide for a ring apparatus incorporating magnetic features for interacting with magnetic locking mechanisms to enhance security for devices such as safes, cabinets, or other access-controlled systems.

It is a further aspect of the embodiments to provide for a ring apparatus incorporating magnets for detachably connecting measuring cups while providing a hands-free, ergonomic tool that is always accessible to the user.

The aforementioned aspects and other objectives and advantages can now be achieved as described herein.

In an embodiment, a multifunctional ring apparatus, can include: a ring portion; at least one magnet connected to or integrated within the ring portion; one or more measuring cups, each measuring cup comprising a magnetized end or a magnet connected thereto; wherein the at least one magnet of the ring portion is configured to detachably connect to the magnetized end or the magnet of any of the one or more measuring cups, thereby enabling secure attachment of the measuring cup to the ring portion; and wherein the magnetic connection permits a plurality of measuring cups to be sequentially or simultaneously attached to the ring portion.

In an embodiment, the ring portion can be configured to fit around a finger of a user.

In an embodiment, the at least one magnet can include one or more magnets among a plurality of magnets connected to or integrated with the ring portion.

In an embodiment, the at least one magnet connected to or integrated with the ring portion can be configured as a neodymium magnet.

In an embodiment, the neodymium magnet can include one or more of, for example: N42, N45, N48, or N52 grades of neodymium.

In an embodiment, the ring portion can include a recess or cavity configured to house or maintain the at least one magnet.

In an embodiment, the one or more measuring cups can include graduated markings to indicate volumetric measurements.

In an embodiment, an apparatus for use in bartending or food preparation, can include: a cutting board having multiple detachable cutting board sections, wherein each cutting board section includes one or more embedded magnets; at least one measuring cup having a magnetized end or an attached magnet; and a magnetized connection system wherein the one or more embedded magnets in each cutting board section are configured to magnetically connect to the magnetized end or magnet of the measuring cup, thereby allowing the measuring cup to be magnetically secured to the cutting board section.

In an embodiment, the cutting board sections can be selectively attachable and detachable from one another using the embedded magnets.

An embodiment of the apparatus can include a carved-out area within at least one of the cutting board sections, the carved-out area being sized to receive and store one or more bartending tools

In an embodiment, the cutting board sections can be configured to align and magnetically attach to each other to form a unified cutting surface.

In an embodiment, the measuring cups can be of different sizes and may be magnetically attachable to any of the cutting board sections.

In an embodiment, the measuring cups can be configured to attach to either cutting board section using the embedded magnets, allowing for a flexible arrangement of tools.

In an embodiment, a method of using a multifunctional ring apparatus for bartending or food preparation, can involve: providing a multifunctional ring apparatus comprising: a ring portion; at least one magnet connected to or integrated within the ring portion; and one or more measuring cups, each measuring cup comprising a magnetized end or a magnet connected thereto.

An embodiment of the method can further involve detachably connecting the at least one magnet of the ring portion to the magnetized end or magnet of any of the one or more measuring cups, thereby enabling secure attachment of the measuring cup to the ring portion; and using the magnetic connection to permit a plurality of measuring cups to be sequentially or simultaneously attached to the ring portion as needed during bartending or food preparation tasks.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention.

FIG. 1 illustrates a side view of a ring apparatus including a ring portion with four magnets attached thereto, in accordance with an embodiment;

FIG. 2 illustrates a side view of the ring apparatus including the ring portion with three magnets attached thereto, in accordance with an embodiment;

FIG. 3 illustrates a side view of the ring apparatus including the ring portion with two magnets attached thereto, in accordance with an embodiment;

FIG. 4 illustrates a side view of the ring apparatus and the ring portion with four magnets attached thereto, in accordance with an embodiment;

FIG. 5 illustrates a more detailed side view of the ring apparatus shown in FIG. 4, in accordance with an embodiment;

FIG. 6 illustrates a top view of a measuring cup, which can be implemented in accordance with an embodiment;

FIG. 7 illustrates a bottom view of a measuring cup and a magnet located at the bottom of measuring cup, in accordance with an embodiment;

FIG. 8 illustrates a schematic diagram of a modified ring apparatus for use with unlocking or locking a locking mechanism associated with a separate device 202 such as a safe, file cabinet or a box or other device, in accordance with an embodiment;

FIG. 9 illustrates an image of a ring apparatus with two magnetically connected measuring cups, in accordance with an embodiment;

FIG. 10 illustrates an image of the ring apparatus without the measuring cups, in accordance with an embodiment;

FIG. 11 illustrates an image of the ring apparatus on a finger of a user's hand, in accordance with an embodiment;

FIG. 12 illustrates another image of the ring apparatus on a finger of a user's hand, in accordance with an embodiment;

FIG. 13 illustrates an image of the ring apparatus with four magnets attached thereto, in accordance with an embodiment;

FIG. 14 illustrates a top view of a cutting board including two cutting board sections and bartending tools, in accordance with an embodiment;

FIG. 15 illustrates a bottom view of the cutting board sections with a group of measuring cups magnetically connected to one of the cutting board sections, in accordance with an embodiment;

FIG. 16 illustrates an image of a top view of the cutting board sections, in accordance with an embodiment;

FIG. 17 illustrates an image of a side view of the cutting board sections shown in FIG. 16, in accordance with an embodiment; and

FIG. 18 illustrates an image of a cutting board section with measuring cups magnetically connected to the cutting board section, in accordance with an embodiment.

It is important to note that while the drawings and figures presented herein are illustrated in black and white, they might have originally been created and displayed in color. As a result, those skilled in the art will understand that even though the images and figures may not display color, they may actually depict features in color.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Furthermore, the term “at least one” as utilized herein can refer to “one or more”. For example, “at least one widget” may refer to “one or more widgets.

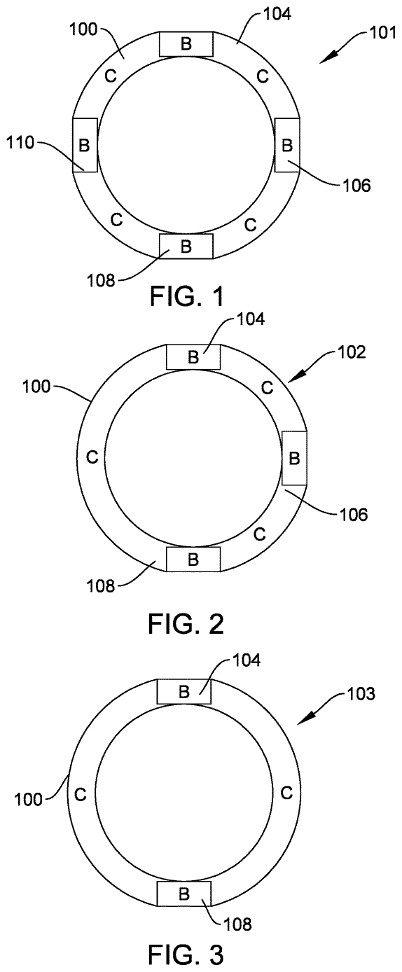

FIG. 1 illustrates a side view of a multifunctional ring apparatus 101 including a ring portion 100 with four magnets 104, 106, 108, 110 attached thereto, in accordance with an embodiment. The four magnets 104, 106, 108, 110 shown in FIG. 1 are also each labeled as “B”. The ring portion 100 is labeled with “C”. Note that the term “multifunctional ring apparatus” may be utilized interchangeably herein with the term “ring apparatus”. It can be appreciated that in some embodiments, the multifunctional ring apparatus 101 may function as a collapsible universal jigger with a magnetic ring.

FIG. 2 illustrates a side view of a ring apparatus 102 including the ring portion 100 with three magnets 104, 106, 108 attached thereto, in accordance with an embodiment. Note that the ring apparatus 102 is a modified version of the ring apparatus 101. That is, the ring apparatus 102 shows three magnets rather than four as shown in FIG. 1. FIG. 2 thus illustrates an alternative embodiment with respect to the ring apparatus 101 shown in FIG. 1.

FIG. 3 illustrates a side view of the ring apparatus 103 including the ring portion 100 with two magnets 104 and 108 attached thereto, in accordance with an embodiment. The ring apparatus 103 shown in FIG. 3 is an alternative embodiment with respect to the ring apparatus 101 and the ring apparatus 102 shown respectively in FIG. 1 and FIG. 2.

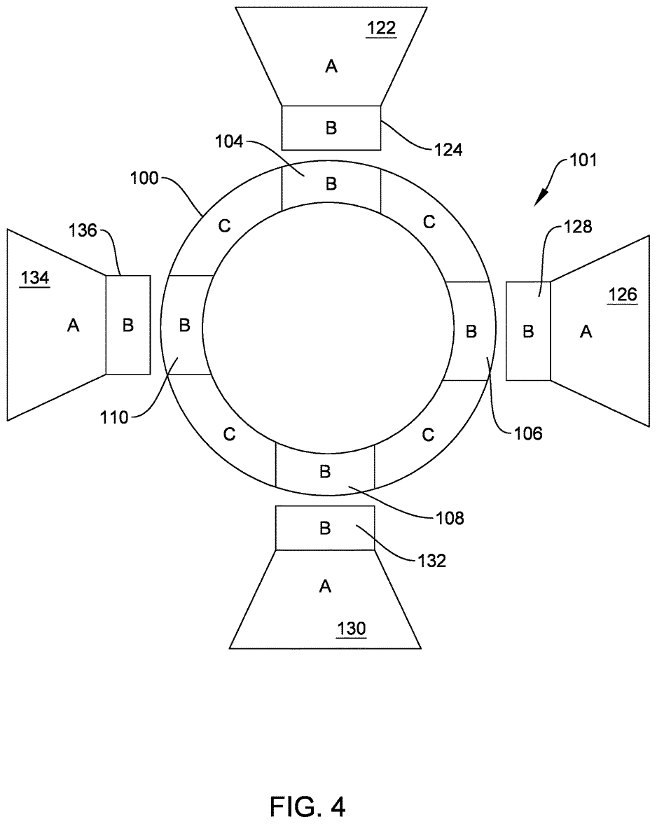

FIG. 4 illustrates a side view of the ring apparatus 101 and the ring portion 100 with one or more magnets 104, 106, 108, 110 that can be attached to the ring apparatus 100, in accordance with an embodiment. The ring portion 100 can be configured to fit around a finger of a user. The magnets 104, 106, 108 and/or 110 can be connected to or integrated within the ring portion 100. The configuration shown in FIG. 4 can include one or more measuring cups 122, 128, 130, and 134. Each measuring cup 122, 128, 130, and 134 can comprise a magnetized end or a magnet connected thereto, such as, for example, respective magnets 124, 128, 132, 136.

The magnets 104, 106, 108, 110 can be configured to detachably connect to the magnetized end or magnets 124, 128, 132, 136 of any of the one or more measuring cups 122, 128, 130, and 134, thereby enabling secure attachment of the measuring cups 122, 128, 130, and 134 to the ring portion 100. This magnetic connection permits a plurality of measuring cups 122, 128, 130, and 134 to be sequentially or simultaneously attached to the ring portion 100.

Note that in some embodiments, the magnets 124, 128, 132, 136 and/or the magnets 104, 106, 108, 110 can comprise neodymium magnets. Such neodymium magnets may comprise, for example, N42, N45, N48, or N52 grades of neodymium. The magnets integrated into the ring apparatus (e.g., magnets 124, 128, 132, 136, and/or magnets 104, 106, 108, 110) can be implemented, for example, as neodymium magnets, which are known for their exceptional magnetic properties. Specifically, neodymium magnets of grades N42, N45, N48, and N52 can be used, offering a balance of strength, reliability, and versatility for various applications.

Neodymium magnets are among the strongest commercially available magnets, delivering a significantly higher magnetic field strength compared to other materials such as ferrite or alnico. Grades such as N42, N45, N48, and N52 provide varying levels of magnetic energy, enabling the apparatus to be tailored for specific use cases. For example, N42 magnets offer a strong, cost-effective solution for general use. N52 magnets can provide maximum strength, ideal for applications requiring higher precision, such as unlocking complex magnetic locks or securely attaching heavier measuring cups.

Due to their high energy density, neodymium magnets achieve superior performance in a compact form factor. This is particularly advantageous in the ring apparatus, where space is limited. Smaller magnets can still provide sufficient magnetic force, allowing the ring to remain lightweight and ergonomic without sacrificing functionality.

Neodymium magnets are highly resistant to demagnetization, ensuring consistent performance over time. This durability is critical in applications where the magnets are frequently used, such as repeatedly attaching and detaching measuring cups or interacting with magnetic locking mechanisms.

The use of neodymium magnets across a range of grades (e.g., N42-N52) allows for flexibility in design. Different grades can be selected to match the magnetic strength requirements for various tasks, such as, for example, ensuring secure attachment of measuring cups while allowing for easy detachment, and providing precise interactions with the lock by leveraging the magnetic strength differences among the magnets embedded in the ring.

For embodiments involving a magnetic locking mechanism, neodymium magnets enable advanced functionalities such as, for example, the strong, consistent magnetic field generated by neodymium magnets can be used to create distinctive signatures required to unlock specific devices. The ability to integrate magnets of varying strengths (e.g., N42 and N52) enhances security by requiring the lock to recognize specific strength variations for unlocking, reducing the likelihood of unauthorized access.

Neodymium magnets are widely used in various industries, ensuring their availability and cost-effectiveness. By incorporating standard grades such as N42-N52, the invention balances performance and affordability, making the apparatus practical for mass production and everyday use. When appropriately coated (e.g., with nickel-copper-nickel plating), neodymium magnets are resistant to corrosion, making them suitable for use in environments prone to moisture or wear, such as bartending stations or kitchen areas.

Neodymium magnets can be manufactured in various shapes and sizes, enabling the design of rings and corresponding devices (e.g., safes or measuring tools) to accommodate specific user preferences and technical requirements. By leveraging the exceptional properties of neodymium magnets, the embodiments can achieve a robust, multifunctional design that enhances performance and user convenience across its applications in liquid measurement and magnetic locking mechanisms.

Note that in some embodiments, the ring portion 100 can be configured to optionally include a recess or cavity designed to house or maintain the magnets 104, 106, 108, 110. This configuration provides several structural and functional benefits, making the design adaptable for various applications. In other embodiments, the magnets 104, 106, 108, 110 may alternatively be directly attached to the ring portion 100 without a dedicated recess or cavity.

A recess or cavity can allow the magnets to be embedded within the ring portion 100, ensuring a sleek and seamless exterior. This reduces the likelihood of the magnets being dislodged during use or subject to wear and tear.

By housing the magnets internally, the design can minimize direct contact with the user's skin, enhancing comfort for prolonged wear. This is particularly important for applications where the ring is worn throughout the day, such as in bartending or for security purposes. The recess or cavity can shield the magnets from environmental factors such as moisture, dust, or accidental impacts, thereby increasing their durability and longevity. The size and shape of the recess can be tailored to accommodate magnets of different dimensions or grades, such as N42, N45, N48, or N52 neodymium magnets, enabling optimization for specific use cases.

Attaching the magnets 104, 106, 108, 110 directly to the surface of the ring portion 100 reduces the complexity of manufacturing, potentially lowering production costs. With direct attachment, the magnets are positioned closer to the external environment, which can increase the strength and precision of their interaction with external devices, such as measuring cups or magnetic locking mechanisms.

Direct attachment allows for various arrangements of the magnets (e.g., linear, radial, or matrix configurations), which can be adjusted based on the intended functionality of the ring apparatus. For example, specific configurations may be optimized to interact with multi-polar magnetic locks or to provide better alignment with detachable accessories. In scenarios where the magnets experience wear or need to be upgraded (e.g., to a higher-grade neodymium magnet), directly attached magnets may be easier to replace compared to those housed in a recess.

The option to include a recess or cavity versus directly attaching the magnets offers versatility in the design, enabling manufacturers or users to select the configuration best suited to their needs. For instance, recessed magnets are ideal for applications requiring a more polished aesthetic, enhanced protection, or user comfort. Directly attached magnets are suitable for applications prioritizing maximum magnetic strength or simplified maintenance.

In some embodiments, the ring portion 100 may incorporate both approaches, with some magnets housed within a recess while others are directly attached. This hybrid design could enable advanced functionality, such as combining internally housed magnets for comfort with exposed magnets for stronger external interactions. By providing flexibility in how the magnets 104, 106, 108, 110 are incorporated into the ring portion 100, the embodiments can offer a customizable solution that can meet a wide range of functional and aesthetic requirements.

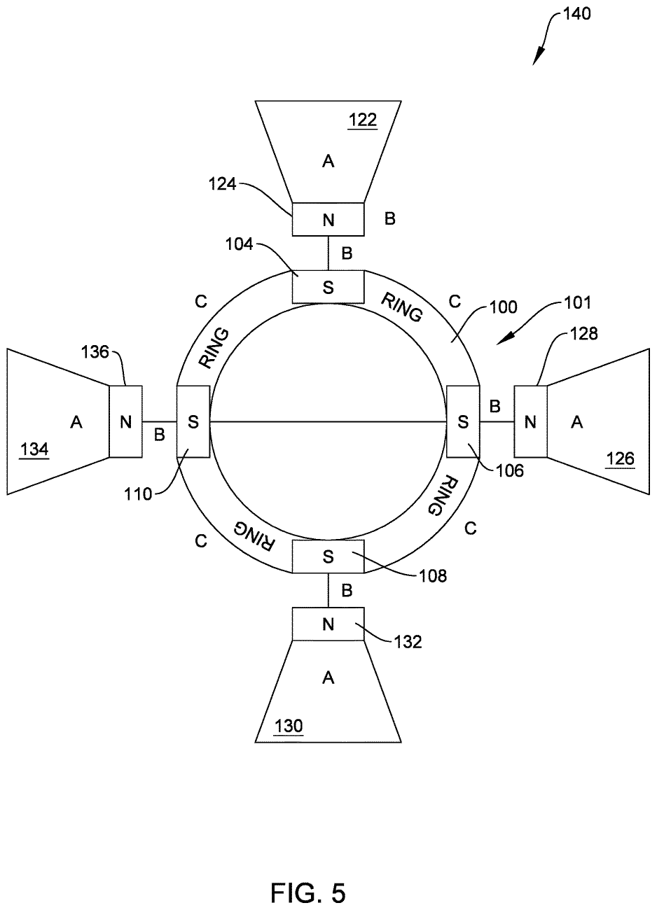

FIG. 5 illustrates a more detailed side view of the ring apparatus 101 shown in FIG. 4, in accordance with an embodiment. In the configuration shown in FIG. 5, groups of magnets are depicted. For example, magnets 104, 106, 108, 110 are connected to the ring portion 100 (also referred to simply as a ‘ring’). The magnet 136 is connected to measuring cup 134. The magnet 124 is connected to measuring cup 122. The magnet 128 is connected to measuring cup 126, and the magnet 132 is connected to measuring cup 130. The magnets associated with the measuring cups are magnetically attracted to their respective counterpart magnets located on the ring apparatus. In this manner, the measuring cup magnets can be connected to the ring apparatus.

The arrangement of magnets depicted in FIG. 5 facilitates secure yet detachable connections between the measuring cups and the ring apparatus 101, allowing for easy assembly and disassembly. Each measuring cup, such as measuring cups 122, 126, 130, and 134, is precisely aligned with its corresponding magnet on the ring portion 100. This configuration not only ensures a firm magnetic bond but also enhances the user experience by providing a consistent and repeatable alignment for the measuring cups. The magnetic coupling enables a modular design, permitting users to interchange or replace individual measuring cups without affecting the functionality of the entire apparatus. Additionally, the design allows for ergonomic handling and efficient storage, as the measuring cups can remain securely attached to the ring apparatus when not in use. Alternatively, the measuring cups can be easily detached from the ring portion 100.

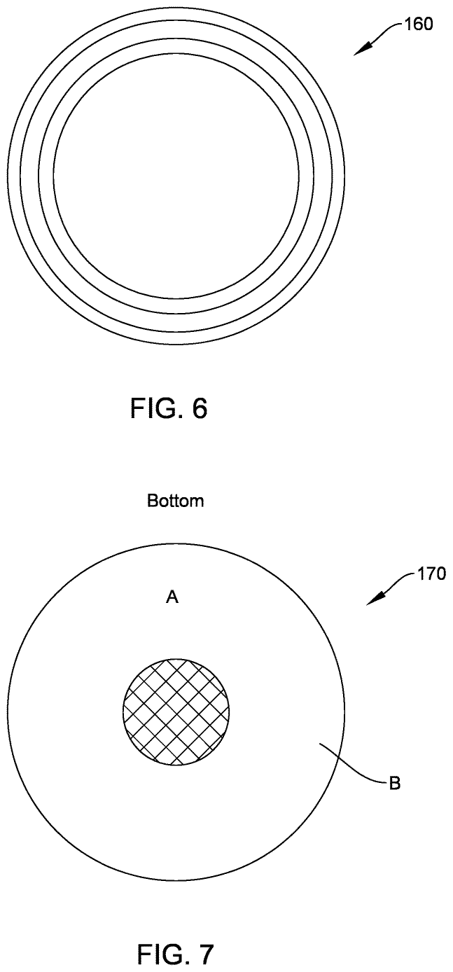

FIG. 6 illustrates a top view 160 of a measuring cup, which can be implemented in accordance with an embodiment. The top view highlights the open end of the measuring cup, which is designed to facilitate accurate scooping and pouring of ingredients. The measuring cup 160 may include measurement indicators, such as etched or embossed markings, on the interior or exterior surface to aid in precise measurements. The ergonomic design of the rim ensures a comfortable grip and minimizes spillage during use.

FIG. 7 illustrates a bottom view of the measuring cup 160, showcasing a magnet 162 embedded or affixed to the bottom surface of the cup in accordance with an embodiment. The placement of the magnet 162 is optimized to ensure a strong and stable magnetic connection with the corresponding magnets on the ring apparatus. The magnet 162 may be enclosed within a protective housing to prevent damage or contamination during use, particularly when the cup is exposed to liquids or fine powders. This bottom view emphasizes the dual functionality of the measuring cup, combining its role as a standard measuring tool with the innovative magnetic coupling feature for secure attachment to the apparatus.

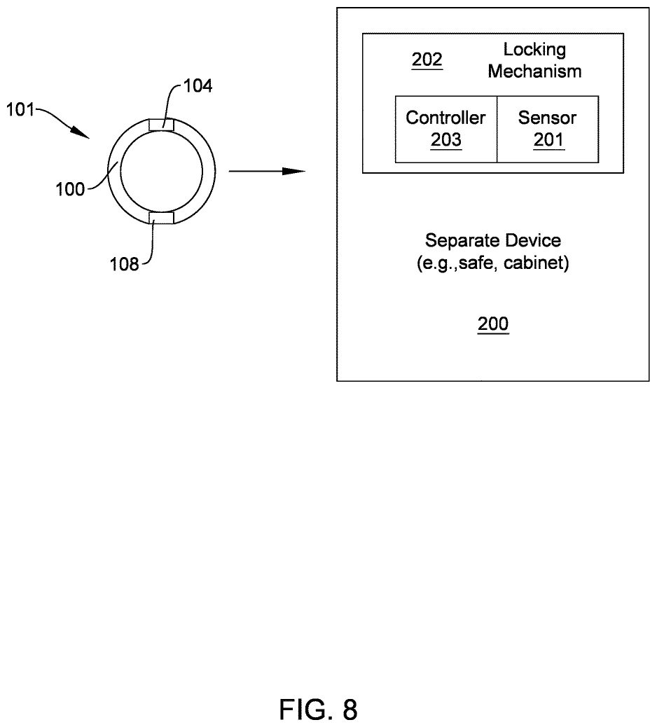

FIG. 8 illustrates a schematic diagram of a modified ring apparatus 101 for use with unlocking or locking a locking mechanism 202 associated with a separate device 202 such as a safe, file cabinet or a box or other device, in accordance with an embodiment. The ring apparatus 101 shown in FIG. 8 can include one or more magnets such as magnets 104, 108, and so on, as discussed previously herein. The ring portion 100 can be configured to fit around a finger of a user. The group of magnets (e.g., magnets 104, 108, etc.) can be integrated with or attached to the ring portion 100, and the group of magnets can contain magnets 104, 108, etc., of different magnetic strengths. The magnets 104, 108, etc. can be configured to interact with the locking mechanism 202 (e.g., a magnetic locking mechanism) on or associated with the device 200, the interaction based on the differences in magnetic strength among the magnets 104, 108, etc. This interaction can enable the magnetic locking mechanism 202 to transition between a locked state and an unlocked state, thereby allowing the separate device 200 to be opened.

In some embodiments, the magnetic locking mechanism 202 of the separate device 200 can be configured to detect the spatial arrangement of the group of magnets 104, 108, etc. on the ring portion 100. The separate device 200 may be, for example, a safe, and the magnetic locking mechanism 202 can include a sensor 201,w which can be configured to measure both magnetic strength and polarity of the magnets 104, 108, etc. on the ring portion 100. The magnetic locking mechanism 202 can require in some embodiments, a sequential movement of the ring portion 100 in a predetermined pattern to unlock the separate device 200.

In some embodiments, the separate device 200 can include an electronic controller 203 configured to authenticate the ring portion 100 based on the magnetic signature generated by the plurality of magnets 104, 108, etc. The ring portion 100 may further include a non-magnetic identifier, and the magnetic locking mechanism 202 may require simultaneous detection of the identifier and the plurality of magnets 104, 108, etc. for unlocking the separate device. Furthermore, the ring portion 100 may be configured to selectively activate or deactivate one or more of the plurality of magnets 104, 108 and so on, to interact with the magnetic locking mechanism 202.

The configuration shown in FIG. 8 depicts a ring apparatus that can include a ring portion configured to fit around a finger of a user, and a plurality of magnets integrated within or attached to the ring portion, wherein the plurality of magnets have different magnetic strengths. The plurality of magnets can be configured to interact with a magnetic locking mechanism of a separate device, the interaction being based on the differences in magnetic strength among the magnets. In addition, this interaction enables the magnetic locking mechanism to transition between a locked state and an unlocked state, thereby allowing the separate device to be opened.

The magnetic locking mechanism of the separate device can be configured to detect the spatial arrangement of the plurality of magnets on the ring portion. In some embodiments, the separate device may be a safe or a device such as a box, and the magnetic locking mechanism can include in some embodiments, a sensor configured to measure both magnetic strength and polarity of the magnets on the ring portion.

The magnetic locking mechanism may require a sequential movement of the ring portion 100 in a predetermined pattern to unlock the separate device. In addition, the separate device may include, in some embodiments, an electronic controller configured to authenticate the ring portion 100 based on the magnetic signature generated by the plurality of magnets.

In other embodiments, the ring portion 100 can include a non-magnetic identifier, and the magnetic locking mechanism can require simultaneous detection of the identifier and the plurality of magnets for unlocking the separate device. The ring portion 100 may be configured in some embodiments to selectively activate or deactivate one or more of the plurality of magnets to interact with the magnetic locking mechanism.

The disclosed embodiments offer a multifunctional ring apparatus that addresses inefficiencies in both the hospitality and security sectors. In bartending, such a device can provide a practical solution for keeping measuring tools within easy reach while ensuring accurate liquid measurement. For security applications, a ring apparatus with magnets of varying strengths offers a wearable, portable alternative to traditional keys or electronic fobs, providing both enhanced security and user convenience.

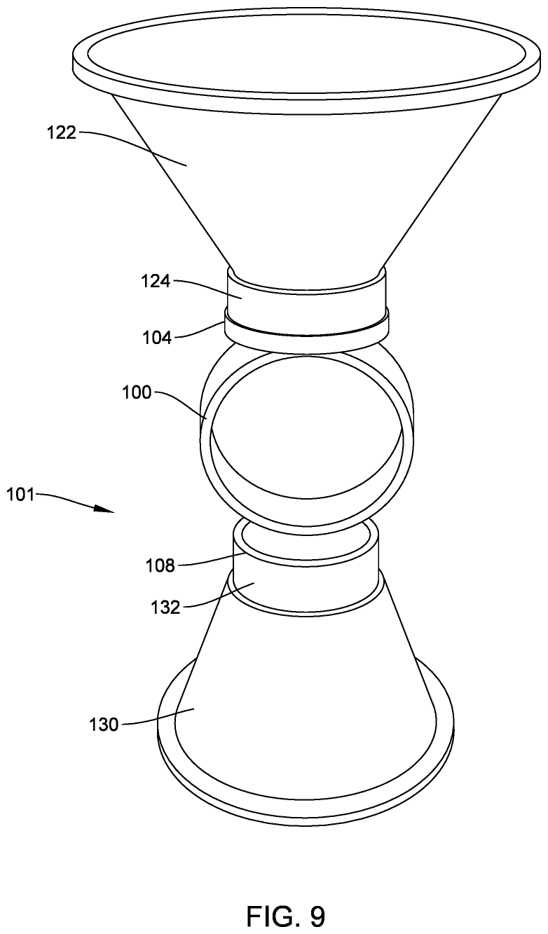

FIG. 9 illustrates an image of the ring apparatus 101 with two magnetically connected measuring cups 122 and 130, in accordance with an embodiment. The embodiment shown in FIG. 9 also includes a magnet 124 that can be connected to another magnet 124, which is in turn connected to a magnet 104 integrated with the ring portion 100 of the ring apparatus 101. This magnetic arrangement allows for a secure yet easily detachable connection between the measuring cups and the ring apparatus. Furthermore, the measuring cup 130 can be connected to a magnet 132, which is in turn connected to the magnet 108 that is integrated with the ring portion 100 of the ring apparatus 101. These magnetic connections provide versatility and convenience, enabling the user to quickly attach or detach the measuring cups as needed while maintaining structural stability during use. This modularity ensures that the measuring cups remain firmly in place while the apparatus is being used for precise measurements.

As discussed previously, the ring apparatus 101 may function as a jigger for use in the bartending industry. Its compact and innovative design allows bartenders to wear the ring apparatus as a functional accessory, ensuring it is readily available for use. The magnetic connections between the ring portion 100 and the measuring cups enable seamless switching between different volume capacities, enhancing the bartender's efficiency and precision. This dual-purpose design integrates style and functionality, making the apparatus a valuable tool in crafting consistently measured cocktails.

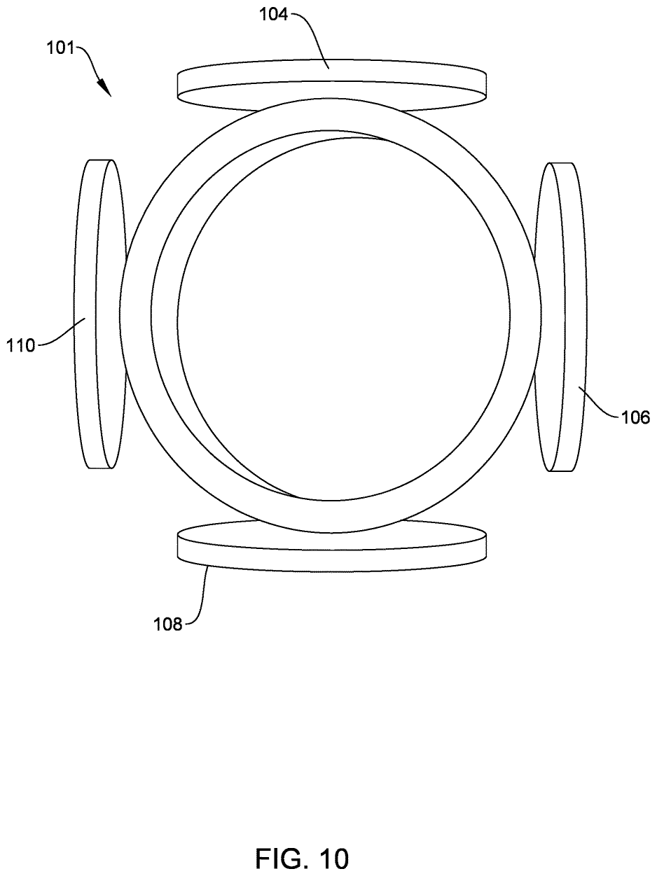

FIG. 10 illustrates an image of the ring apparatus 101 without the measuring cups, in accordance with an embodiment. In this configuration, the ring apparatus 101 showcases its compact and sleek design, emphasizing its adaptability and aesthetic appeal. The ring portion 100 of the apparatus is visible, along with the integrated magnets, which can be strategically positioned to facilitate the attachment of measuring cups or other compatible components when needed.

This embodiment highlights the utility of the ring apparatus 101 as a standalone accessory, suitable for wear as a stylish and functional piece of jewelry. Without the measuring cups attached, the apparatus retains its ergonomic form, ensuring comfort for the user when worn on the hand. The design underscores the apparatus's versatility, allowing bartenders or users in other industries to keep the device readily available for use while maintaining a professional appearance. Additionally, the absence of measuring cups in this configuration makes the ring apparatus 101 easy to store or transport, adding to its practicality and user convenience.

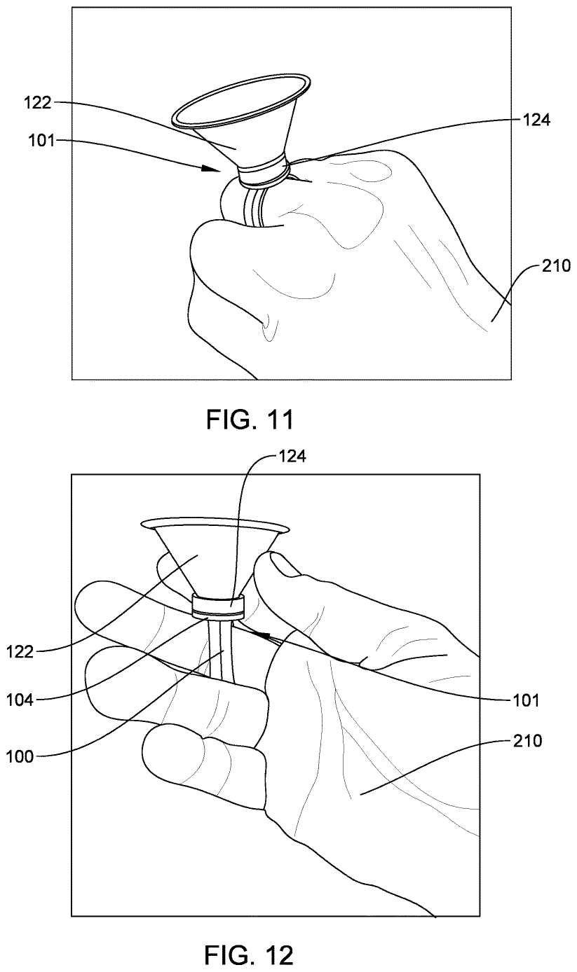

FIG. 11 illustrates an image of the ring apparatus 101 worn on a user's finger, in accordance with an embodiment. In this configuration, the apparatus is shown with a single measuring cup 122 securely connected to the ring portion 100 via a magnetic coupling between magnet 104, integrated with the ring apparatus 101, and magnet 124 attached to the measuring cup 122. This magnetic connection provides a secure yet easily detachable mechanism for attaching the measuring cup, allowing for convenient use during bartending or other applications.

The image shown in FIG. 11 also depicts additional measuring cups placed on a tabletop nearby. These measuring cups may vary in size, offering different volumetric capacities to accommodate a range of measurement needs. The modular design of the apparatus allows the user to seamlessly swap the measuring cups based on the specific requirements of a given task, ensuring versatility and precision

This embodiment of FIG. 11 highlights the practicality of the ring apparatus 101, enabling users to wear it comfortably on their finger for quick access while keeping additional measuring cups within reach. The ergonomic design ensures that the apparatus remains functional without obstructing the user's movements, making it particularly beneficial for bartenders who require efficient, on-the-go measurement tools. The magnetic attachment system also minimizes the risk of spills or inaccuracies, as the measuring cups remain firmly in place during use. This innovative approach combines functionality and convenience, elevating the user experience in professional and personal settings.

FIG. 12 illustrates another image of the ring apparatus 101 worn on a user's finger, in accordance with an embodiment. In this configuration, the user's thumb is shown supporting the measuring cup 122, which is securely attached to the ring portion 100 via the magnetic coupling between magnets 104 and 124, as previously described. The ergonomic positioning of the measuring cup allows the user to stabilize it effortlessly while pouring or measuring liquids, ensuring accuracy and reducing the likelihood of spills.

The image depicted in FIG. 12 emphasizes the intuitive and user-friendly design of the apparatus, which leverages the natural movements of the hand to enhance functionality. By using the thumb as a stabilizing support, the apparatus allows for single-handed operation, a critical feature in fast-paced environments such as bartending or cooking. This hands-free convenience not only improves efficiency but also enables the user to multitask, such as holding a bottle or shaker in the other hand while measuring ingredients.

The magnetic attachment system including the magnets 104 and 124 can ensure that the measuring cup 122 remains securely in place during use while also allowing for quick detachment when switching between cups of different sizes. This adaptability makes the ring apparatus 101 a versatile tool that can accommodate a wide range of measurement needs with ease. The embodiment shown in FIG. 12 highlights the innovative combination of comfort, precision, and practicality, making the apparatus an essential accessory for professionals and enthusiasts alike.

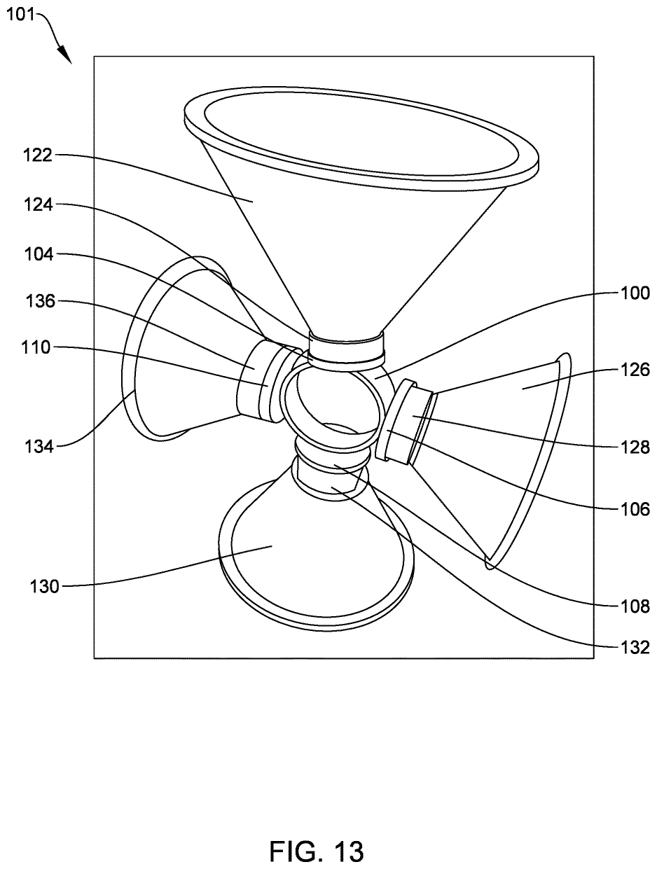

FIG. 13 illustrates an image of the ring apparatus 101 featuring magnets 104, 106, 108, and 110, which can be attached to or integrated within the ring portion 100, in accordance with an embodiment. The ring portion 100 can be configured to fit comfortably around a user's finger, serving as both a functional tool and an ergonomic accessory. The magnets 104, 106, 108, and 110 may be strategically positioned within or affixed to the ring portion 100 to provide secure and reliable connections to additional components.

The embodiment shown in FIG. 13 also can include one or more measuring cups 122, 128, 130, and 134, which are designed to be magnetically attachable to the ring apparatus. Each measuring cup features a magnetized end or a magnet connected thereto, such as respective magnets 124, 128, 132, and 136. These measuring cups may be of uniform size and shape in some embodiments, providing consistent measurement capabilities. In other embodiments, the measuring cups may vary in size, shape, and volumetric capacity, allowing for a versatile range of applications to suit different measurement needs.

The magnets 104, 106, 108, and 110 on the ring portion 100 can be configured to detachably connect to the corresponding magnetized ends or magnets 124, 128, 132, and 136 of the measuring cups. This magnetic system enables secure attachment of the measuring cups to the ring apparatus, providing stability during use while allowing for quick and easy detachment. The design supports both sequential and simultaneous attachment of multiple measuring cups, accommodating various user preferences and requirements. For instance, a user can attach a single measuring cup for precise measurements or connect multiple cups for convenience in multitasking scenarios.

As previously discussed, the magnets 124, 128, 132, 136, and the magnets 104, 106, 108, and 110 integrated into the ring apparatus can comprise neodymium magnets. These magnets are known for their exceptional strength and reliability, making them ideal for applications requiring secure and durable connections. Specifically, grades such as N42, N45, N48, and N52 neodymium magnets may be utilized, offering a range of magnetic properties tailored to the apparatus's functional demands. The use of neodymium magnets can ensure that the measuring cups remain firmly attached during operation, while their detachment requires minimal effort, preserving the efficiency and user-friendliness of the design.

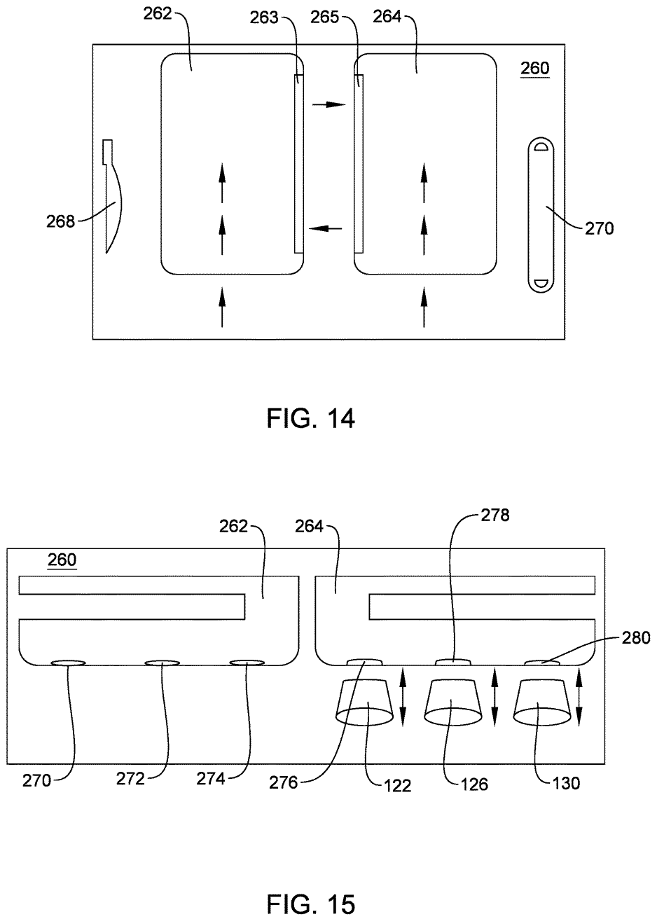

FIG. 14 illustrates a top view of a cutting board 260 that comprises two distinct cutting board sections, 262 and 264, along with bartending tools 268 and 270, in accordance with an embodiment. The modular design of the cutting board 260 provides enhanced versatility and functionality, making it a useful tool for bartenders and kitchen professionals alike.

The cutting board section 262 includes an area 263, which can be embedded with a group of magnets (note shown in FIG. 14). These magnets can be designed to securely attach to measuring cups, such as those described in previous embodiments. This feature allows bartenders or users to keep measuring cups conveniently accessible during preparation tasks, reducing the risk of misplacing them and improving workflow efficiency. Similarly, the cutting board section 264 includes an area 265, which also incorporates magnets for attaching to measuring cups or other compatible magnetic tools.

Additionally, area 265 on cutting board section 264 can be designed to magnetically connect to area 263 on cutting board section 262, enabling the two sections to be joined together securely. This magnetic connection facilitates easy assembly and disassembly of the cutting board sections, providing the user with the flexibility to configure the cutting board 260 according to specific needs. For instance, the sections can be used separately for distinct tasks or combined to create a larger, unified workspace.

The cutting board 260 can be associated with bartending tools 268 and 270, which may include essential items such as a muddler, bottle opener, or citrus press, depending on the embodiment. These tools are designed to complement the cutting board's functionality, streamlining drink preparation and promoting both efficiency and organization during bartending tasks. By integrating these tools into the cutting board system, the cutting board 260 provides a convenient all-in-one solution for professionals and enthusiasts alike

In some embodiments, the cutting board 260 itself may feature dedicated sections or openings formed within the cutting board sections 262 and 264 for storing bartending tools 268 and 270. These storage areas may be recessed or include compartments, ensuring that the tools are securely held in place and readily accessible during use. This integrated storage capability not only eliminates the need for separate toolkits but also enhances portability, allowing the cutting board 260 and its associated tools to be transported as a single compact unit.

The innovative design leverages the use of magnets to further enhance modularity and functionality. For example, the magnets embedded in the cutting board sections 262 and 264 may be used to securely hold magnetic bartending tools or measuring cups in place during preparation. This compatibility with other magnetic bartending accessories expands the utility of the cutting board 260, making it adaptable to various user preferences and scenarios

By combining a cutting surface, integrated storage for tools, and magnetic compatibility, the cutting board 260 offers a comprehensive solution tailored to the needs of bartenders. Its thoughtful design promotes seamless transitions between tasks, reduces workspace clutter, and ensures that essential tools and accessories are always within reach. Whether in a professional bar setting or at home, the cutting board 260 exemplifies a blend of practicality, innovation, and convenience.

FIG. 15 illustrates another view of the cutting board sections 262 and 264, with a group of measuring cups 122, 126, and 130 magnetically connected to cutting board section 264 via magnets 276, 278, and 280 embedded in section 264, in accordance with an embodiment. These measuring cups are securely attached to the cutting board through the strong magnetic fields generated by the embedded magnets, ensuring that the cups remain in place during use while also allowing for easy removal when needed. The magnetic system provides an efficient way to store and access measuring cups, reducing clutter and increasing the organization of the workspace

In addition to the magnets in section 264, cutting board section 262 is also equipped with magnets 270, 272, and 274 embedded within it. These magnets work in the same manner as those in section 264, allowing the measuring cups or other magnetic tools to be securely attached to section 262 as well. The inclusion of magnets in both cutting board sections 262 and 264 provides flexibility, allowing the user to attach and store the measuring cups in either section depending on the task at hand or personal preference. This dual-section magnetic arrangement enhances the overall modularity of the cutting board, making it adaptable for different types of use, whether it's for storing measuring cups, bartending tools, or other accessories

Furthermore, each cutting board section, 262 and 264, can feature carved-out areas specifically designed for storing bartending tools. These recessed compartments can be tailored to fit tools such as muddlers, citrus presses, or bottle openers, ensuring they are securely held within the cutting board and easy to access when needed. The carved-out areas help maintain an organized workspace by providing designated storage for each tool, reducing the need for additional storage containers or toolkits. This design also improves portability, as all the essential bartending tools are integrated into the cutting board system, making it a compact and efficient solution for both professional and home bartenders. Together, the magnetic attachments and the carved storage areas contribute to the cutting board's overall functionality and ease of use, allowing users to keep their tools organized, accessible, and ready for use, all within one convenient and modular system.

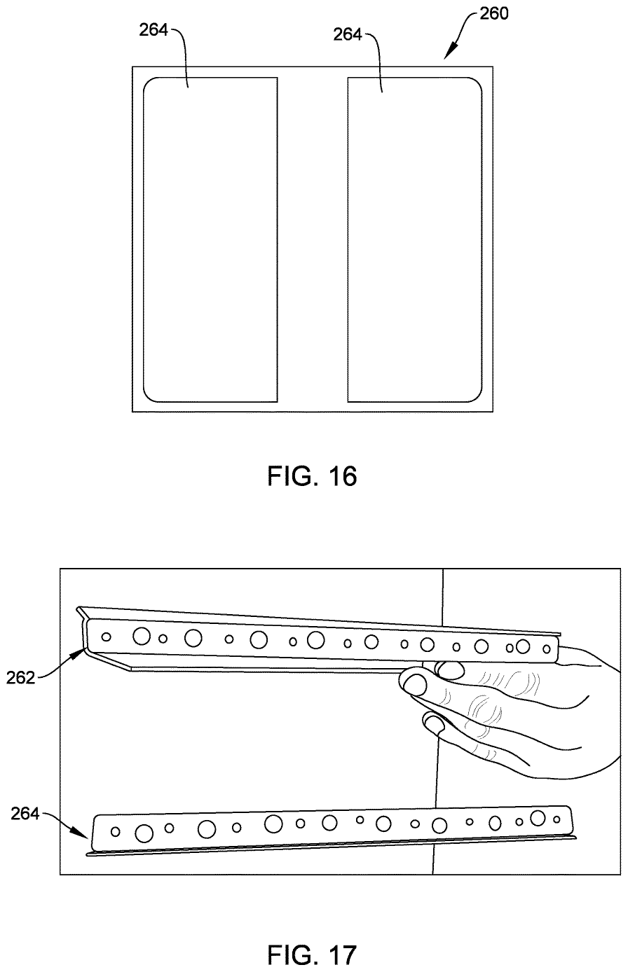

FIG. 16 illustrates a top view of the cutting board sections 262 and 264, forming part of the cutting board 260, in accordance with an embodiment. The top view showcases how these two modular sections are designed to work together as a cohesive unit. Each section is carefully crafted to include embedded magnets and storage spaces, ensuring the cutting board remains both functional and organized. The design prioritizes usability by making it easy for bartenders and kitchen professionals to seamlessly transition between different tasks, all while maintaining a clutter-free workspace.

FIG. 17 presents a side sectional view of the cutting board sections 262 and 264, as shown in FIG. 16, providing an in-depth look at the internal structure of the cutting board 260, in accordance with an embodiment. The image reveals that a series of magnets is embedded within both cutting board sections, 262 and 264. These magnets are strategically placed to ensure secure attachment of measuring cups and other tools to the cutting board, allowing them to be kept within arm's reach while preventing them from shifting or falling during use. The embedded magnets enhance the cutting board's versatility, enabling it to store multiple tools at once while maintaining a streamlined and efficient workspace.

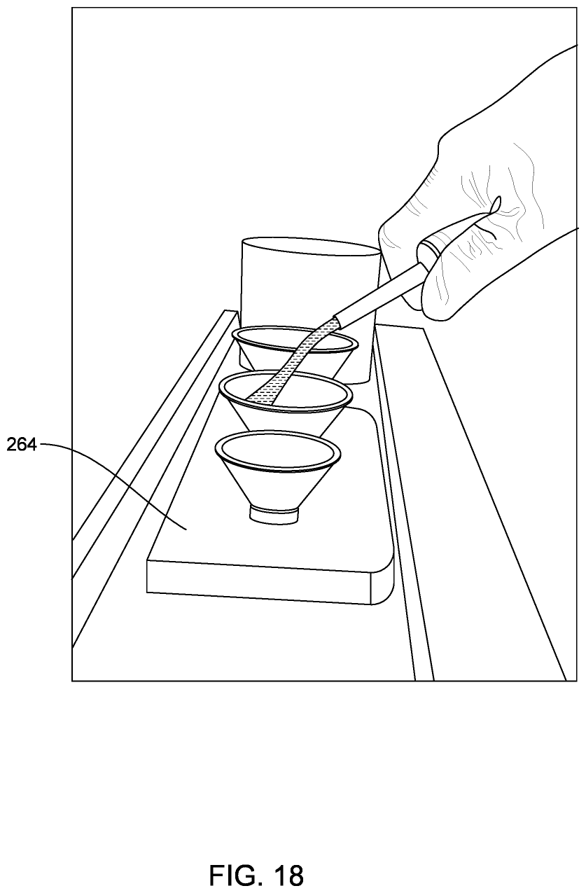

FIG. 18 illustrates a close-up view of cutting board section 264, where a group of measuring cups is magnetically connected to the section. The embedded magnets in section 264 hold the measuring cups securely in place, making them easily accessible during drink preparation or other tasks. This magnetic connection ensures that the measuring cups stay attached even during rigorous use, while also allowing for quick and convenient removal when needed. The modular nature of the cutting board allows for a dynamic and flexible setup, where users can add, remove, or reposition the measuring cups and tools as necessary.

In a bartending or kitchen environment, space can be limited, making it crucial to maximize efficiency and functionality in the available area. The multi-board structure of cutting board 260, which can be composed of multiple cutting board sections (such as sections 262 and 264), can be especially valuable for optimizing limited space. Whether used on a bar lip, bar ledge, kitchen counter, or near a dishwasher, the cutting board's modular design allows for a compact yet highly efficient work surface. By providing an organized area for measuring cups, bartending tools, and other accessories, the cutting board 260 helps bartenders and kitchen professionals stay organized, ensuring that essential tools are always within easy reach. Its versatile and space-efficient design makes it an ideal choice for environments where maximizing usable workspace is essential, allowing users to maintain a streamlined, organized approach to their tasks. It should be appreciated that the cutting board 260 may include multiple sections 262, 264, etc., and can be customizable in shape and size to accommodate, for example, different sizes and shapes of bar lips, bar ledges, counter space, and so on. For example, bar ledges and bar lips may be curved in some bartending environments rather than simply straight or linear.

The embodiments aim to bridge these gaps by offering an innovative, dual-purpose ring apparatus with distinct features for liquid measurement and magnetic locking interaction. This novel approach leverages the integration of magnetic technology into a wearable form factor, addressing long-standing challenges in both fields.

The concept of a wearable unlocking device, such as a ring, offers a significant advantage. A ring apparatus equipped with magnets of varying strengths can act as a personal, discreet key, reducing the risk of unauthorized access. Unlike traditional tools, the ring's unique magnetic configuration can provide a highly customizable locking and unlocking mechanism that enhances both security and user convenience.

Based on the foregoing, it can be appreciated that a number of different embodiments including preferred and alternative embodiments are disclosed herein. For example, in an embodiment, a multifunctional ring apparatus can include a ring portion 100 and one or more magnets connected to or integrated within the ring portion 100. The multifunctional ring apparatus can further include one or more measuring cups, each measuring cup comprising a magnetized end or a magnet connected thereto, wherein the one or more magnets of the ring portion 100 can be configured to detachably connect to the magnetized end or the magnet of any of the one or more measuring cups, thereby enabling secure attachment of the measuring cup to the ring portion 100. Furthermore, the magnetic connection can be configured to allow one or more or a group of measuring cups to be sequentially or simultaneously attached to the ring portion 100.

In an embodiment, the ring portion 100 can be configured to fit around a finger of a user.

In an embodiment, the one or more magnets can comprise one or more magnets among a plurality of magnets connected to or integrated with the ring portion 100.

In an embodiment, the one or more magnets connected to or integrated with the ring portion 100 can each comprise a neodymium magnet.

In an embodiment, the neodymium magnet can comprise at least one of: N42, N45, N48, or N52 grades of neodymium.

In an embodiment, the ring portion 100 can include a recess or cavity configured to house or maintain the at least one magnet.

In an embodiment, the one or more measuring cups can include graduated markings to indicate volumetric measurements.

In an embodiment, an apparatus for use in bartending or food preparation, can include a cutting board having multiple detachable cutting board sections, wherein each cutting board section includes one or more embedded magnets; at least one measuring cup having a magnetized end or an attached magnet; and a magnetized connection system wherein the one or more embedded magnets in each cutting board section are configured to magnetically connect to the magnetized end or magnet of the measuring cup, thereby allowing the measuring cup to be magnetically secured to the cutting board section.

In an embodiment, the cutting board sections can be selectively attachable and detachable from one another using the embedded magnets.

In an embodiment, a carved-out area within at least one of the cutting board sections can be configured, wherein the carved-out area is sized to receive and store one or more bartending tools.

In an embodiment, the cutting board sections can be configured to align and magnetically attach to each other to form a unified cutting surface.

In an embodiment, the measuring cups can be of different sizes and can be magnetically attachable to any of the cutting board sections.

In an embodiment, the measuring cups can be configured to attach to either cutting board section using the embedded magnets, allowing for a flexible arrangement of tools.

In an embodiment, a method for using a multifunctional ring apparatus for bartending or food preparation, can involve: providing a multifunctional ring apparatus comprising: a ring portion 100; at least one magnet connected to or integrated within the ring portion 100; and one or more measuring cups, each measuring cup comprising a magnetized end or a magnet connected thereto.

An embodiment of the method can also involve detachably connecting the at least one magnet of the ring portion 100 to the magnetized end or magnet of any of the one or more measuring cups, thereby enabling secure attachment of the measuring cup to the ring portion 100 and using the magnetic connection to permit a plurality of measuring cups to be sequentially or simultaneously attached to the ring portion 100 as needed during bartending or food preparation tasks.

In an embodiment of the method, the ring portion 100 can be fitted around a finger of a user, allowing the user to easily access and detach measuring cups while using the ring apparatus.

In an embodiment of the method, the at least one magnet can comprise one or more magnets among a plurality of magnets connected to or integrated with the ring portion 100, providing enhanced flexibility in attaching measuring cups to different locations on the ring apparatus.

In an embodiment of the method, the at least one magnet can be connected to or integrated with the ring portion 100 comprises a neodymium magnet, providing a strong magnetic connection between the measuring cups and the ring apparatus.

In an embodiment of the method, the neodymium magnet can comprise at least one of: N42, N45, N48, or N52 grades of neodymium, ensuring the strength and durability of the magnetic connection.

In an embodiment of the method, the ring portion 100 can include a recess or cavity configured to house or maintain the at least one magnet, allowing for a streamlined and secure configuration of the magnetized connection system.

In an embodiment of the method, the one or more measuring cups can be configured to include graduated markings to indicate volumetric measurements, enabling precise measurements during bartending or food preparation tasks.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A multifunctional ring apparatus, comprising:
a ring portion;
at least one magnet connected to or integrated within the ring portion;
one or more measuring cups, each measuring cup comprising a magnetized end or a magnet connected thereto;
wherein the at least one magnet of the ring portion is configured to detachably connect to the magnetized end or the magnet of any of the one or more measuring cups, thereby enabling secure attachment of the measuring cup to the ring portion; and
wherein the magnetic connection permits a plurality of measuring cups to be sequentially or simultaneously attached to the ring portion.

2. The multifunctional ring apparatus of claim 1 wherein the ring portion is configured to fit around a finger of a user.

3. The multifunctional ring apparatus of claim 1 wherein the at least one magnet comprises one or more magnets among a plurality of magnets connected to or integrated with the ring portion.

4. The multifunctional ring apparatus of claim 1 wherein the at least one magnet connected to or integrated with the ring portion comprises a neodymium magnet.

5. The multifunctional ring apparatus of claim 3, wherein the neodymium magnet comprises at least one of: N42, N45, N48, or N52 grades of neodymium.

6. The multifunctional ring apparatus of claim 1, wherein the ring portion includes a recess or cavity configured to house or maintain the at least one magnet.

7. The multifunctional ring apparatus of claim 1, wherein the one or more measuring cups include graduated markings to indicate volumetric measurements.

8. An apparatus for use in bartending or food preparation, comprising:
a cutting board having multiple detachable cutting board sections, wherein each cutting board section includes one or more embedded magnets;
at least one measuring cup having a magnetized end or an attached magnet;
a magnetized connection system wherein the one or more embedded magnets in each cutting board section are configured to magnetically connect to the magnetized end or magnet of the measuring cup, thereby allowing the measuring cup to be magnetically secured to the cutting board section.

9. The apparatus of claim 8, wherein the cutting board sections are selectively attachable and detachable from one another using the embedded magnets.

10. The apparatus of claim 8, further comprising a carved-out area within at least one of the cutting board sections, the carved-out area being sized to receive and store one or more bartending tools.

11. The apparatus of claim 8, wherein the cutting board sections are configured to align and magnetically attach to each other to form a unified cutting surface.

12. The apparatus of claim 8, wherein the measuring cups are of different sizes and are magnetically attachable to any of the cutting board sections.

13. The apparatus of claim 8, wherein the measuring cups are configured to attach to either cutting board section using the embedded magnets.

14. A method for using a multifunctional ring apparatus for bartending or food preparation, the method comprising:
providing a multifunctional ring apparatus comprising:
a ring portion;
at least one magnet connected to or integrated within the ring portion;
one or more measuring cups, each measuring cup comprising a magnetized end or a magnet connected thereto;
detachably connecting the at least one magnet of the ring portion to the magnetized end or magnet of any of the one or more measuring cups, thereby enabling secure attachment of the measuring cup to the ring portion; and
using the magnetic connection to permit a plurality of measuring cups to be sequentially or simultaneously attached to the ring portion as needed during bartending or food preparation tasks.

15. The method of claim 14, wherein the ring portion is fitted around a finger of a user, allowing the user to easily access and detach measuring cups while using the ring apparatus.

16. The method of claim 14, wherein the at least one magnet comprises one or more magnets among a plurality of magnets connected to or integrated with the ring portion, providing enhanced flexibility in attaching measuring cups to different locations on the ring apparatus.

17. The method of claim 14, wherein the at least one magnet connected to or integrated with the ring portion comprises a neodymium magnet, providing a strong magnetic connection between the measuring cups and the ring apparatus.

18. The method of claim 17, wherein the neodymium magnet comprises at least one of: N42, N45, N48, or N52 grades of neodymium.

19. The method of claim 14, wherein the ring portion includes a recess or cavity configured to house or maintain the at least one magnet.

20. The method of claim 14, wherein the one or more measuring cups include graduated markings to indicate volumetric measurements, enabling measurements during bartending or food preparation tasks.
